(19) United States
(12) Patent Application Publication
(10) Pub. No.: US 2006/0101256 A1
(43) Pub. Date: May 11, 2006

(54) Looping instructions for a single instruction, multiple data execution engine

(76) Inventors: Michael K. Dwyer, El Dorado Hills, CA (US); Hong Jiang, San Jose, CA (US)

Correspondence Address: BUCKLEY, MASCHOFF, TALWALKAR LLC, 5 ELM STREET, NEW CANAAN, CT, 06840, US

(21) Appl. No.: 10/969,731

(22) Filed: Oct. 20, 2004

(51) Int. Cl. G06F 9/44

(52) U.S. Cl. 712/241

(57) ABSTRACT

According to some embodiments, looping instructions are provided for a Single Instruction, Multiple Data (SIMD) execution engine. For example, when a first loop instruction is received at an execution engine information in an n-bit loop mask register may be copied to an n-bit wide, m-entry deep loop stack.

### BACKGROUND

To improve the performance of a processing system, an instruction may be simultaneously executed for multiple operands of data in a single instruction period. Such an instruction may be referred to as a Single Instruction, Multiple Data (SIMD) instruction. For example, an eight-channel SIMD execution engine might simultaneously execute an instruction for eight 32-bit operands of data, each operand being mapped to a unique compute channel of the SIMD execution engine. In the case of a non-SIMD processor, an instruction may be a “loop” instruction such that an associated set of instructions may need to be executed multiple times (e.g., a particular number of times or until a condition is satisfied).

### BRIEF DESCRIPTION OF THE DRAWINGS

FIGS. 1 and 2 illustrate processing systems.

FIG. 3 illustrates a SIMD execution engine according to some embodiments.

FIGS. 4-5 illustrate a SIMD execution engine executing a DO instruction according to some embodiments.

FIGS. 6-8 illustrate a SIMD execution engine executing a REPEAT instruction according to some embodiments.

FIG. 9 illustrates a SIMD execution engine executing a BREAK instruction according to some embodiments.

FIG. 10 is a flow chart of a method according to some embodiments.

FIGS. 11-14 illustrate a SIMD execution engine executing nested loop instructions according to some embodiments.

FIG. 15 illustrates a SIMD execution engine able to execute both loop and conditional instructions according to some embodiments.

FIG. 16 is a flow chart of a method according to some embodiments.

FIGS. 17-18 illustrate an example of a SIMD execution engine according to one embodiment.

FIG. 19 is a block diagram of a system according to some embodiments.

FIG. 20 illustrates a SIMD execution engine executing a CONTINUE instruction according to some embodiments.

FIG. 21 is a flow chart of a method of processing a CONTINUE instruction according to some embodiments.

### DETAILED DESCRIPTION

Some embodiments described herein are associated with a “processing system.” As used herein, the phrase “processing system” may refer to any device that processes data. A processing system may, for example, be associated with a graphics engine that processes graphics data and/or other types of media information. In some cases, the performance of a processing system may be improved with the use of a SIMD execution engine. For example, a SIMD execution engine might simultaneously execute a single floating point SIMD instruction for multiple channels of data (e.g., to accelerate the transformation and/or rendering three-dimensional geometric shapes). Other examples of processing systems include a Central Processing Unit (CPU) and a Digital Signal Processor (DSP).

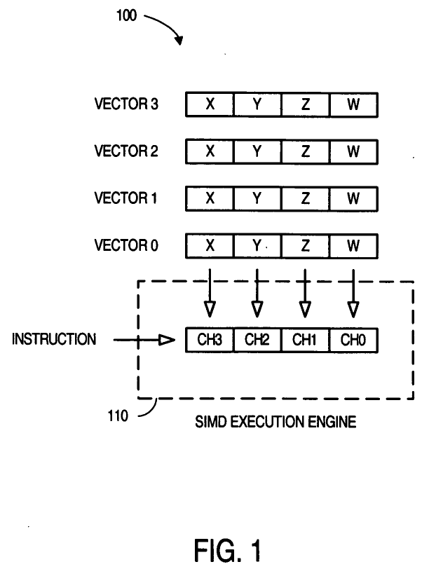

FIG. 1 illustrates one type of processing system 100 that includes a SIMD execution engine 110. In this case, the execution engine 110 receives an instruction (e.g., from an instruction memory unit) along with a four-component data vector (e.g., vector components X, Y, Z, and W, each having bits, laid out for processing on corresponding channels 0 through 3 of the SIMD execution engine 110). The engine 110 may then simultaneously execute the instruction for all of the components in the vector. Such an approach is called a “horizontal,” “channel-parallel,” or “array of structures” implementation. Although some embodiments described herein are associated with a four-channel SIMD execution engine 110, note that an SIMD execution engine could have any number of channels more than one (e.g., embodiments might be associated with a thirty-two channel execution engine).

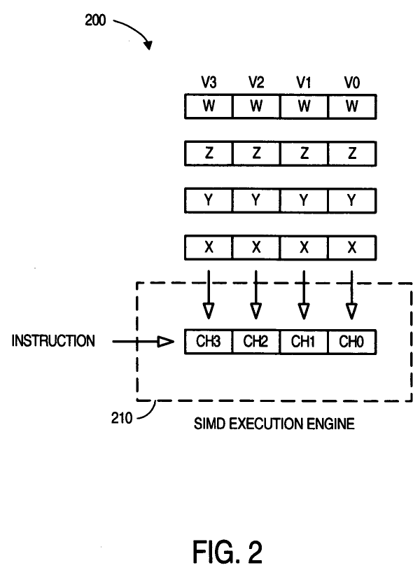

FIG. 2 illustrates another type of processing system 200 that includes a SIMD execution engine 210. In this case, the execution engine 210 receives an instruction along with four operands of data, where each operand is associated with a different vector (e.g., the four X components from vectors 0 through 3). The engine 210 may then simultaneously execute the instruction for all of the operands in a single instruction period. Such an approach is called a “vertical,” “channel-serial,” or “structure of arrays” implementation.

According to some embodiments, an SIMD instruction may be a “loop” instruction that indicates that a set of associated instructions should be executed, for example, a particular number of times or until a particular condition is satisfied. Consider, for example, the following instructions:

DO {
sequence of instructions
} WHILE <condition>

Here, the sequence of instruction will be executed as long as the “condition is true.” When such an instruction is executed in a SIMD fashion, however, different channels may produce different results of the <condition> test. For example, the condition might be defined such that the sequence of instructions should be executed as long as Var1 is, not zero (and the sequence of instructions might manipulate Var1 as appropriate). In this case, Var1 might be zero for one channel and non-zero for another channel.

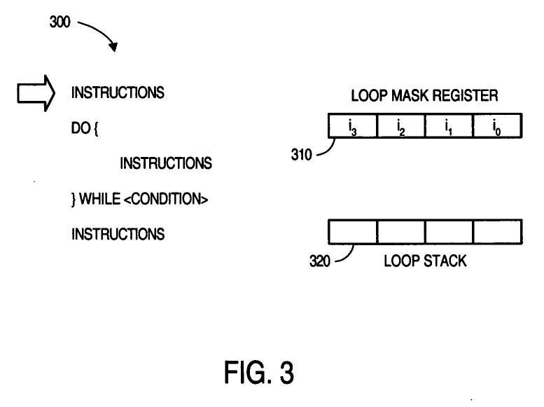

FIG. 3 illustrates a four-channel SIMD execution engine 300 according to some embodiments. The engine 300 includes a four-bit loop mask register 310 in which each bit is associated with a corresponding compute channel. The loop mask register 310 might comprise, for example, a hardware register in the engine 300. The engine 300 may also include a four-bit wide loop “stack” 320. As used herein, the term “stack” may refer to any mechanism to store and reconstruct previous mask values. One example of a stack is would be a bit-per-channel stack mechanism.

The loop stack 320 might comprise, for example, series of hardware registers, memory locations, and/or a combination of hardware registers and memory locations. Although the engine 300, the conditional mask register 310, and the conditional stack 320 illustrated in FIG. 3 are four channels wide, note that implementations may be other numbers of channels wide (e.g., x channels wide), and each compute channel may be capable of processing a y-bit operand, so long as there is a 1:1 correspondence between the compute channel, mask channel, and loop stack channel.

The engine 300 may receive and simultaneously execute instructions for four different channels of data (e.g., associated with four compute channels). Note that in some cases, fewer than four channels may be needed (e.g., when there are less than four valid operands). As a result, the loop mask register 310 may be initialized with an initialization vector indicating which channels have valid operands and which do not (e.g., operands i₀ through i₃, with a “1” indicating that the associated channel is currently enabled). The loop mask vector 310 may then be used to avoid unnecessary processing (e.g., an instruction might be executed only for those operands in the loop mask register 310 that are set to “1”). According to another embodiment, the loop mask register 310 is simply initialized to all ones (e.g., it is assumed that all channels are always enabled). In some cases, information in the loop mask register 310 might be combined with information in other registers (e.g., via a Boolean AND operation) and the result may be stored in an overall execution mask register (which may then used to avoid unnecessary or inappropriate processing).

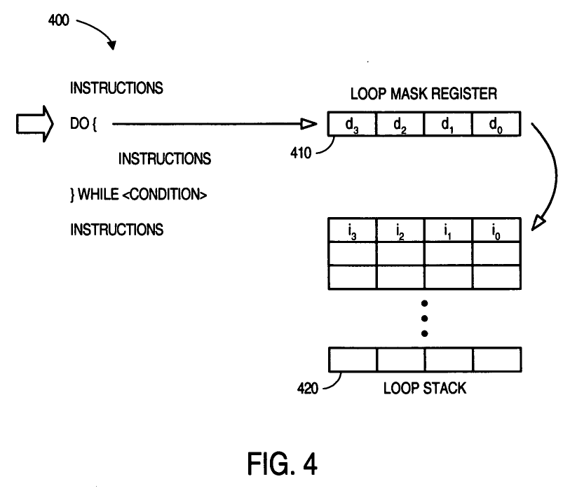

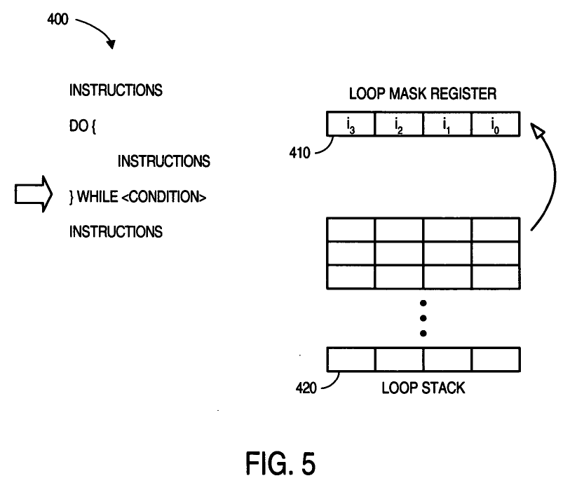

FIGS. 4-5 illustrate a four-channel SIMD execution engine 400 executing a DO instruction according to some embodiments. As before, the engine 400 includes a loop mask register 410 and a loop stack 420. In this case, however, the loop stack 420 is m-entries deep. Note that, for example, in the case of a ten-entry deep stack, the first four entries in the stack 420 might be hardware registers while the remaining six entries are stored in memory.

When the engine 400 receives a loop instruction (e.g., a DO instruction), as illustrated in FIG. 4, the data in the loop mask register 410 is copied to the top of the loop stack 420. Moreover, loop information is stored into the loop mask register 410. The loop information might initially indicate, for example, which of the four channels were active when the DO instruction was first encountered (e.g., operands d₀ through d₃, with a “1” indicating that the associated channel is active).

The set of instructions associated with the DO loop are then executed for each channel in accordance with the loop mask register 410. For example, if the loop mask register 410 was “1110,” the instructions in the loop would be executed for the data associated with the three most significant operands but not the least significant operand (e.g., because that channel is not currently enabled).

When a WHILE statement associated with the DO instruction is encountered, a condition is evaluated for the active channels and the results are stored back into the loop mask register 410 (e.g., by a Boolean AND operation). For example, if the loop mask register 410 was “1110” before the WHILE statement was encountered the condition might be evaluated for the data associated with the three most significant operands. The result is then stored in the loop mask register 410. If at least one of the bits in the loop mask register 410 is still “1,” the set of loop instructions are executed again for all channels that have a loop mask register value of “1.” By way of example, if the condition associated with the WHILE statement resulted in a “110x” result (where x was not evaluated because that channel was not enabled), “1100” may be stored in the loop mask register 410. When the instructions associated with the loop are then re-executed, the engine 400 will do so only for the data associated with the two most significant operands. In this case, unnecessary and/or inappropriate processing for the loop may be avoided. Note that no Boolean AND operation might be needed if the update is limited to only active channels.

When the WHILE statement is eventually encountered and the condition is evaluated such that all of the bits in the loop mask register 410 are now “0,” the loop is complete. Such a condition is illustrated in FIG. 5. In this case, the information from the top of the loop stack 420 (e.g., the initialization vector), is returned to the loop mask register 410, and subsequent instructions may be executed. That is, the data at the top of the loop stack 420 may be transferred back into the loop mask register 410 to restore the contents that indicate which channels contained valid data prior to entering the loop. Further instructions may then be executed for data associated with channels that are enabled. As a result, the SIMD engine 400 may efficiently process a loop instruction.

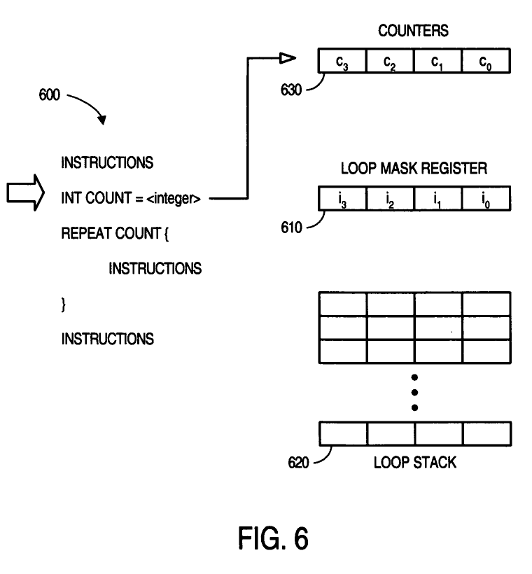

In addition to a DO instruction, FIGS. 6-8 illustrate a SIMD execution engine 600 executing a REPEAT instruction according to some embodiments. As before, the engine 600 includes a four-bit loop mask register 610 and a four-bit wide, m-entry deep loop stack 620. In this case, the engine 600 further includes a set of counters 630 (e.g., a series of hardware registers, memory locations, and/or a combination of hardware registers and memory locations). The loop mask register 610 may be initialized with, for example, an initialization vector i₀ through i₆, with a “1” indicating that the associated channel has valid operands.

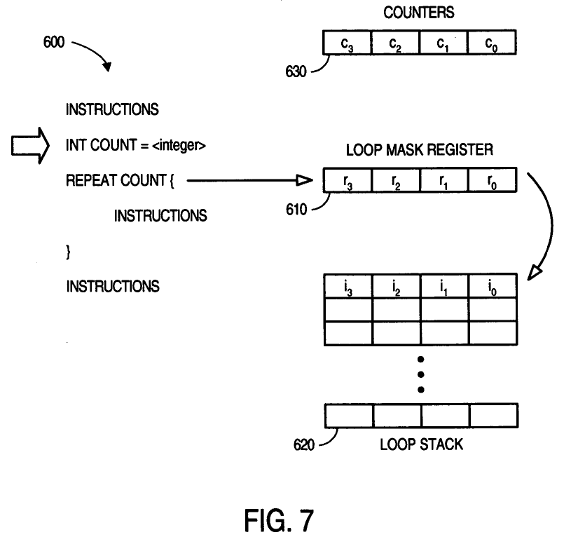

When the engine 600 encounters a INT COUNT=<integer> instruction associated with a REPEAT loop, as illustrated in FIG. 6, the value <integer> may be stored in the counters 630. When the REPEAT instruction is then encountered, as illustrated in FIG. 7, the data in the loop mask register 610 is copied to the top of the loop stack 620. Moreover, loop information is stored into the loop mask register 610. The loop information might initially indicate, for example, which of the four channels were active when the REPEAT instruction was first encountered (e.g., operands r₀ through r₆, with a “1” indicating that the associated channel is active).

The set of instructions associated with the REPEAT loop are then executed for each channel in accordance with the loop mask register 610. For example, if the loop mask register 610 was “1000,” the instructions in the loop would be executed only for the data associated with the most significant operands.

When the end of the REPEAT loop is reached (e.g., as indicated by a “}” or a NEXT instruction), each counter 630 associated with an active channel is decremented. According to some embodiments, if any counter 630 has reached zero, the associated bit in the loop mask register 610 is set to zero. If at least one of the bits in the loop mask register 610 and/or a counter 630 is still “1,” the REPEAT block is executed again.

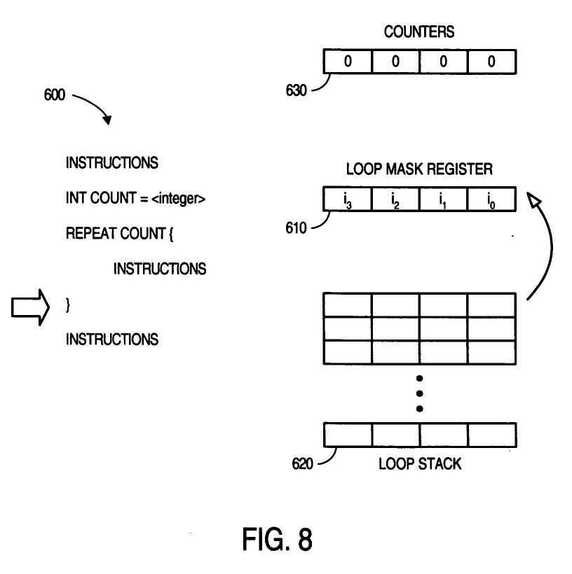

When all of the bits in the loop mask register 610 and/or a counter 630 are “0,” the REPEAT loop is complete. Such a condition is illustrated in FIG. 8. In this case, the information from the loop stack 620 (e.g., the initialization vector), is returned to the loop mask register 610, and subsequent instructions may be executed.

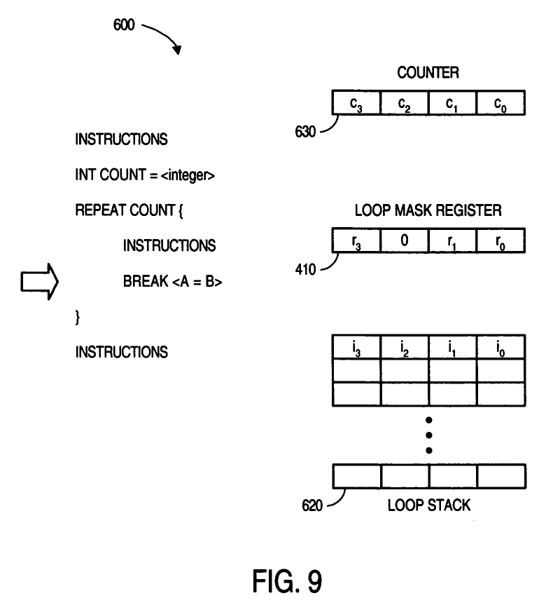

FIG. 9 illustrates the SIMD execution engine 600 executing a BREAK instruction according to some embodiments. In particular, the BREAK instruction is within a REPEAT loop and will be executed on if X is greater than Y. In this example, X is greater than Y for second most significant channel and not greater than Y for the other channels. In this case, the corresponding bit in the loop mask vector is set to “0.” If all of the bits in the loop mask vector 610 are “0,” the REPEAT loop may be terminated (and the top of the loop stack 620 may be returned to the loop mask register 410). Note that more than one BREAK instruction might exist in a loop. Consider, for example, the following instructions:

```
DO {
        Instructions
        BREAK <condition 1>
        Instructions
        BREAK <condition 2>
        Instructions
} While <condition 3>
```

In this case, the BREAK instruction might be executed if either condition 1 or 2 is satisfied.

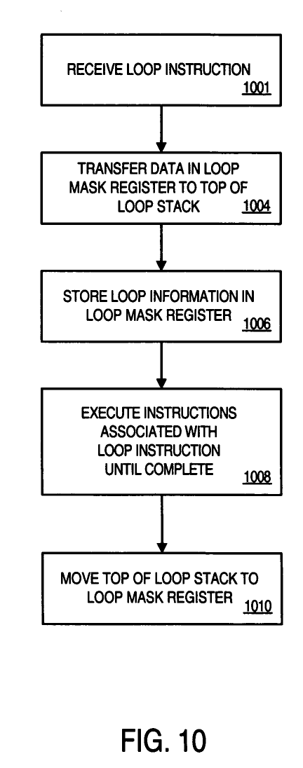

FIG. 10 is a flow chart of a method according to some embodiments. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 1002, a loop instruction is received. For example, a DO or REPEAT instruction might be encountered by a SIMD execution engine. The data in a loop mask register is then transferred to the top of a loop stack at 1004 and loop information is stored in the loop mask register 1006. For example, an indication of which channels currently have valid operands might be stored in the loop mask register.

At 1008, instructions associated with the loop instructions are executed in accordance with information in the loop mask register until the loop is complete. For example, a block of instructions associated with a DO loop or a REPEAT loop may be executed until all of the bits in the loop mask register are “0.” When the loop is finished executing, the information at the top of the loop stack may then be moved back to the loop mask register at 1010.

As described with respect to FIG. 3, a loop stack might be one entry deep. When the loop is more than one entry deep, however, a SIMD engine might be able to handle nested loop instructions (e.g., when a second loop block is “nested” inside of a first loop block). Consider, for example, the following set of instructions:

```
DO {
        first subset of instructions
        DO {
                second subset of instructions
        } WHILE <second condition>
        third subset of instructions
} WHILE <first condition>
```

In this case, the first and third subsets of instructions should be executed for the appropriate channels while the first condition is true, and the second subset of instructions should only be executed while both the first and second conditions are true.

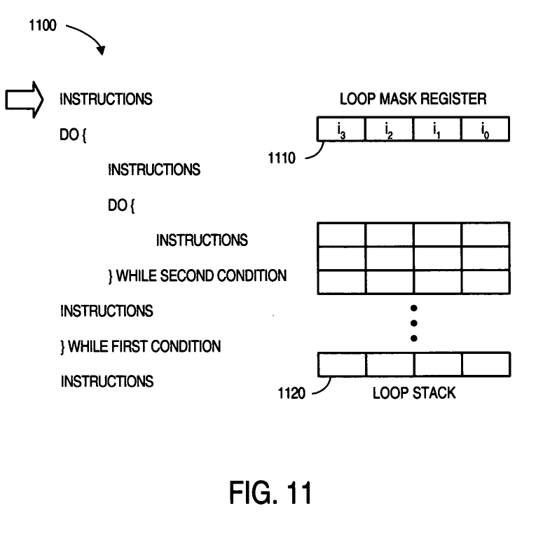

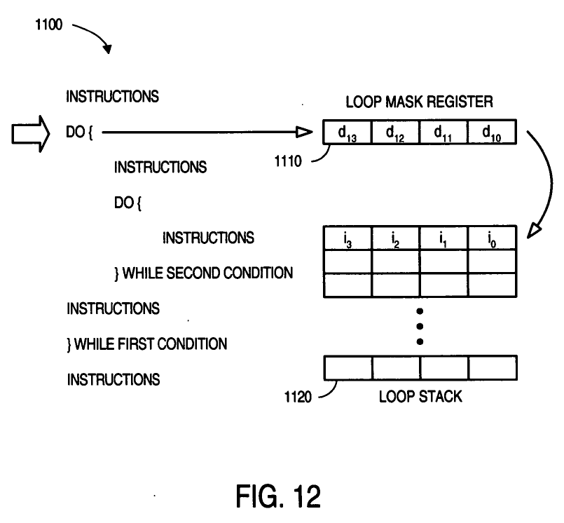

FIGS. 11-14 illustrate a SIMD execution engine 1100 that includes a loop mask register 1110 (e.g., initialized with an initialization vector) and a multi-entry deep loop stack 1120. As illustrated in FIG. 12, the information in loop mask register 1110 is copied to the top of the stack 1120 (i₀ through i₃), and first loop information is stored into the loop mask register 1110 (d₁₀ through d₁₃) when the first DO instruction is encountered. The engine 1100 may then execute the loop block associated with the first loop instruction for multiple operands of data as indicated by the information in the loop mask register 1110.

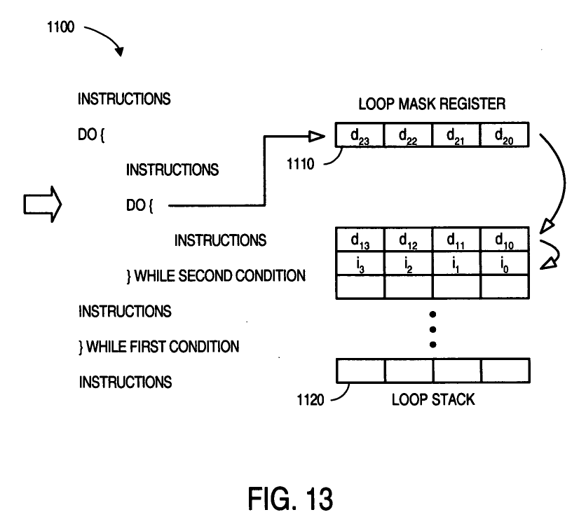

FIG. 13 illustrates the execution of another, nested loop instruction (e.g., a second DO statement) according to some embodiments. In this case, the information currently in the loop mask register 1110 (d₁₀ through d₁₃) is copied to the top of the stack 1120. As a result, the information that was previously at the top of the stack 1120 (e.g., initialization vector i₀ through i₃) has been pushed down by one entry. The engine 1100 also stores second loop information into the loop mask register (d₂₀ through d₂₃).

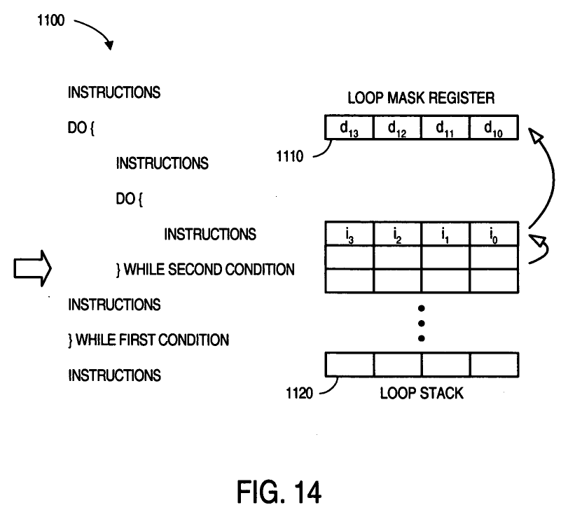

The loop block associated with the second loop instruction may then be executed as indicated by the information in the loop mask register 1110 (e.g., and, each time the second block is executed the loop mask register 1110 may be updated based on the condition associated with the second loop's WHILE instruction). When the second loop's WHILE instruction eventually results in every bit of the loop mask register 1110 being “0,” as illustrated in FIG. 14, the data at the top of the loop stack 1120 (e.g., d₁₀ through d₁₃) may be moved back into the loop mask register 1110. Further instructions may then be executed in accordance with the loop mask register 1120. When the first loop block completes (not illustrated in FIG. 14), the initialization vector would be transferred back into the loop mask register 1110 and further instructions may be executed for data associated with enabled channels.

Note that the depth of the loop stack 1120 may be associated with the number of levels of loop instruction nesting that are supported by the engine 1100. According to some embodiments, the loop stack 1120 is only be a single entry deep (e.g., the stack might actually be an n-operand wide register). Also note that a “0” bit in the loop mask register 1110 might indicate a number of different things, such as: (i) the associated channel is not being used, (ii) an associated WHILE condition for the present loop is not satisfied, or (iii) an associated condition of a higher-higher level loop is not satisfied.

According to some embodiments, an SIMD engine may also support “conditional” instructions. Consider, for example, the following set of instructions:

IF (condition)
subset of instructions
END IF

Here, the subset of instructions will be executed when the condition is “true.” As with loop instructions, however, when a conditional instruction is simultaneously executed for multiple channels of data different channels may produce different results. That is, the subset of instructions may need to be executed for some channels but not others.

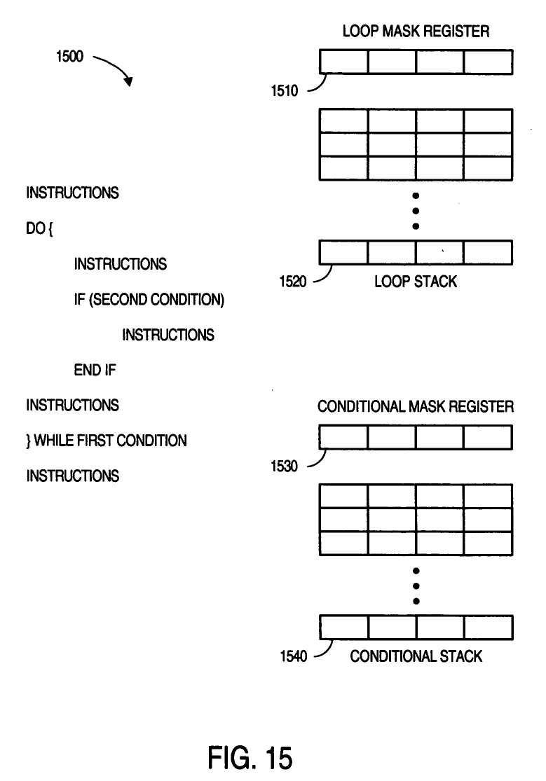

FIG. 15 illustrates a four-channel SIMD execution engine 1500 according to some embodiments. The engine 1500 includes a loop mask register 1510 and a loop stack 1520 according to any of the embodiments described herein.

Moreover, according to this embodiment the engine 1500 includes a four-bit conditional mask register 1530 in which each bit is associated with a corresponding compute channel. The conditional mask register 1530 might comprise, for example, a hardware register in the engine 1500. The engine 1500 may also include a four-bit wide, m-entry deep conditional stack 1540. The conditional stack 1540 might comprise, for example, series of hardware registers, memory locations, and/or a combination of hardware registers and memory locations (e.g., in the case of a ten entry deep stack, the first four entries in the stack 1540 might be hardware registers while the remaining six entries are stored in memory).

The execution of conditional instructions may be similar to those of loop instructions. For example, when the engine 1500 receives a conditional instruction (e.g., an “IF” statement), the data in the conditional mask register 1530 may be copied to the top of the conditional stack 1540. Moreover, instructions may be executed for each of the four operands in accordance with the information in the conditional mask register 1530. For example, if the initialization vector was “1110,” the condition associated with an IF statement would be evaluated for the data associated with the three most significant operands but not the least significant operand (e.g., because that channel is not currently enabled). The result may then stored in the conditional mask register 1530 and used to avoid unnecessary and/or inappropriate processing for the statements associated with the IF statement. By way of example, if the condition associated with the IF statement resulted in a “110x” result (where x was not evaluated because the channel was not enabled), “1100” may be stored in the conditional mask register 1530. When other instructions associated with the IF statement are then executed, the engine 1500 will do so only for the data associated with the two most significant operand.

When the engine 1500 receives an indication that the end of instructions associated with a conditional instruction has been reached (e.g., and “END IF” statement), the data at the top of the conditional stack 1540 (e.g., the initialization vector) may be transferred back into the conditional mask register 1530 restoring the contents that indicate which channels contained valid data prior to entering the condition block. Further instructions may then be executed for data associated with channels that are enabled. As a result, the SIMD engine 1500 may efficiently process a conditional instruction.

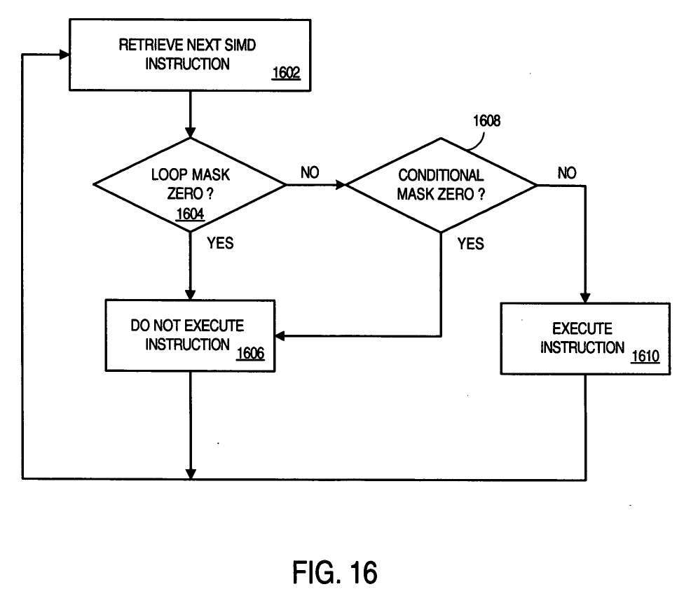

According to some embodiments, instructions are executed in accordance with both the loop mask register 1510 and the conditional mask register 1530. For example, FIG. 16 is an example of a method according to such an embodiment. At 1602, the engine 1500 retrieves the next SIMD instruction. If the bit in the loop mask register 1510 for a particular channel is “0” at 1604, the instruction is not executed for that channel at 1606. If the bit in the conditional mask register 1530 for the channel is “0” 1t 1608, the instruction is also not executed for that channel. Only if the bits in both the loop mask register 1510 and conditional mask register 1530 are “1” will the instruction be executed at 1610. In this way, the engine 1500 may efficiently execute both loop and conditional instructions.

In some cases, conditional instructions may be nested within loop instructions and/or loop instructions may be nested within conditional instructions. Note that a BREAK might occur from within n-levels of nested branches. As a result, the conditional stack 1540 may be “unwound” by, for example, popping the conditional mask vector <count> times to restore it to the state prior to loop entry. The <count> might be tracked, for example, by having a compiler track the relative nesting level of conditional instructions between the loop instruction and the BREAK instruction.

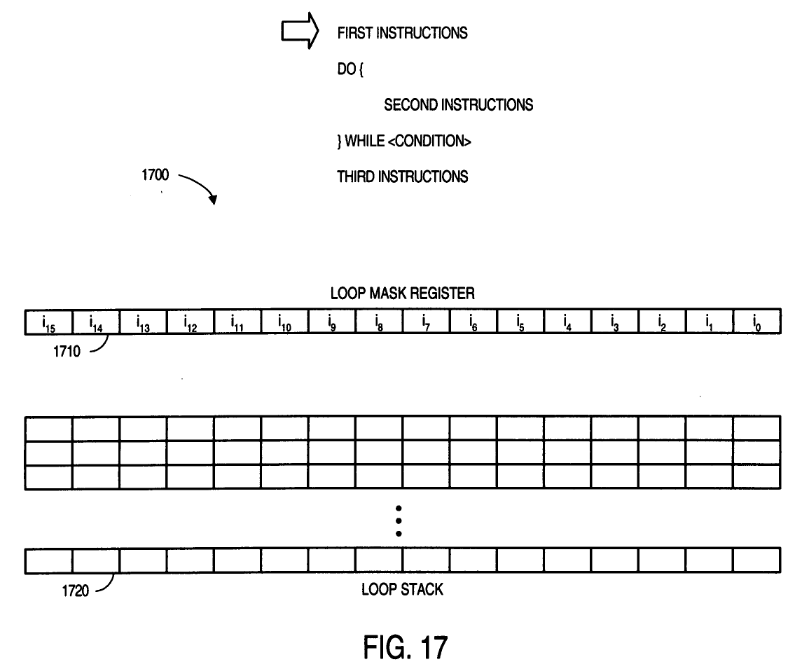

FIG. 17 illustrates an SIMD engine 1700 with a sixteen-bit loop mask register 1710 (each bit being associated to one of sixteen corresponding compute channels) and a sixteen-bit wide, m-entry deep loop stack 1720. The engine 1700 may receive and simultaneously execute instructions for sixteen different channels of data (e.g., associated with sixteen compute channels). Because fewer than sixteen channels might be needed, however, the loop mask register is initialed with an initialization vector i₀ through i₁₅, with a “1” indicating that the associated channel is enabled.

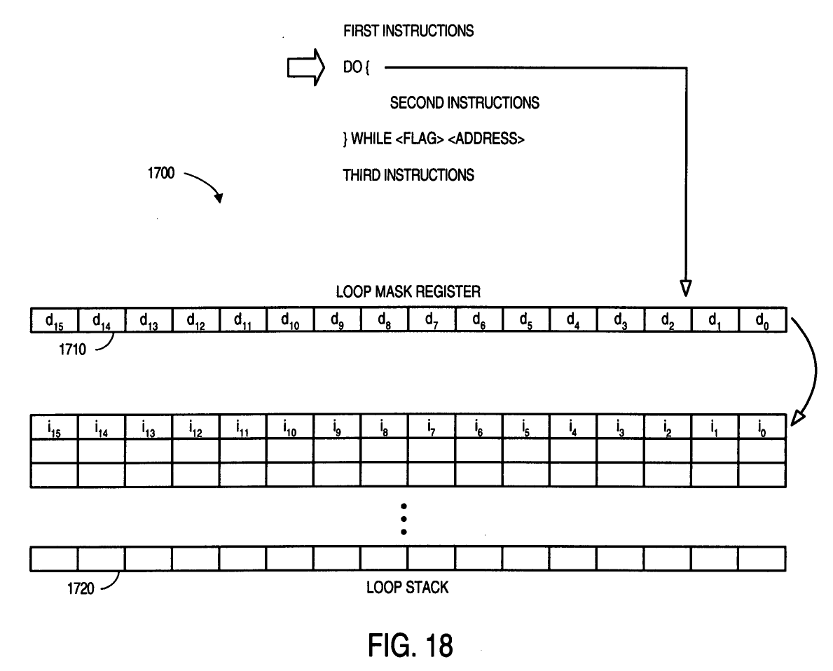

As illustrated in FIG. 18, when the engine 1700 receives a DO instruction, the data in the loop mask register 1710 is copied to the top of the loop stack 1720. Moreover, DO information d₀ through d₁₅ is stored into the loop mask register 1710. The DO information might indicate, for example, which of the sixteen channels were active when the DO instruction was encountered.

The second set of instructions is then executed for each channel in accordance with the loop mask register 1710. When the WHILE instruction is encountered, the engine 1700 examines a <flag> for each of the active channel. The <flag> might have been set, for example, by one of the second set of instructions (e.g., immediately prior to the WHILE instruction). If no <flag> is true for any channel, the DO loop is complete. In this case, the initialization vector i₀ through i₁₅ may be returned to the loop mask register 1710 and the third set of instructions may be executed.

If at least one <flag> is true, the loop mask register 1710 may be updated as appropriate, and the engine 1700 may jump to an <address> defined by the WHILE instruction (e.g., pointing to the beginning of the second set of instructions).

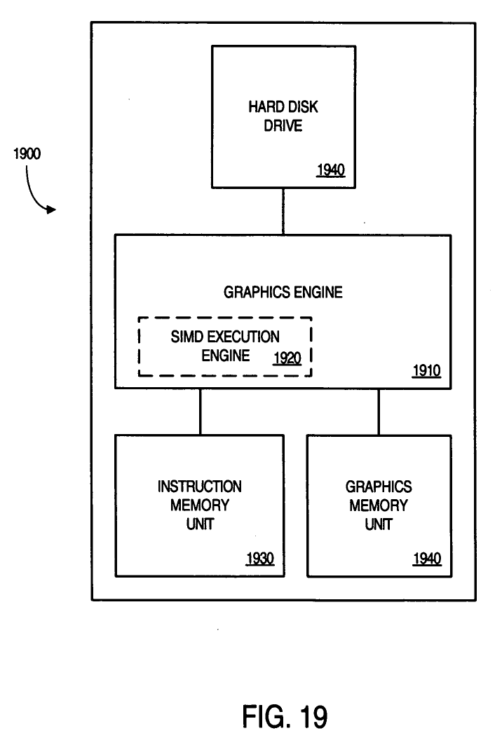

FIG. 19 is a block diagram of a system 1900 according to some embodiments. The system 1900 might be associated with, for example, a media processor adapted to record and/or display digital television signals. The system 1900 includes a graphics engine 1910 that has an n-operand SIMD execution engine 1920 in accordance with any of the embodiments described herein. For example, the SIMD execution engine 1920 might have an n-operand loop mask vector and an n-operand wide, m-entry deep loop stack in accordance with any of the embodiments described herein. The system 1900 may also include an instruction memory unit 1930 to store SIMD instructions and a graphics memory unit 1940 to store graphics data (e.g., vectors associated with a three-dimensional image). The instruction memory unit 1930 and the graphics memory unit 1940 may comprise, for example, Random Access Memory (RAM) units.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described with respect to a separate loop mask register and loop stack, any embodiment might be associated with only a single loop stack (e.g., and the current mask information might be associated with the top entry in the stack).

Moreover, although different embodiments have been described, note that any combination of embodiments may be implemented (e.g., a REPEAT or BREAK statement and an ELSE statement might include an address). Moreover, although examples have used “0” to indicate a channel that is not enabled according to other embodiments a “1” might instead indicate that a channel is not currently enabled.

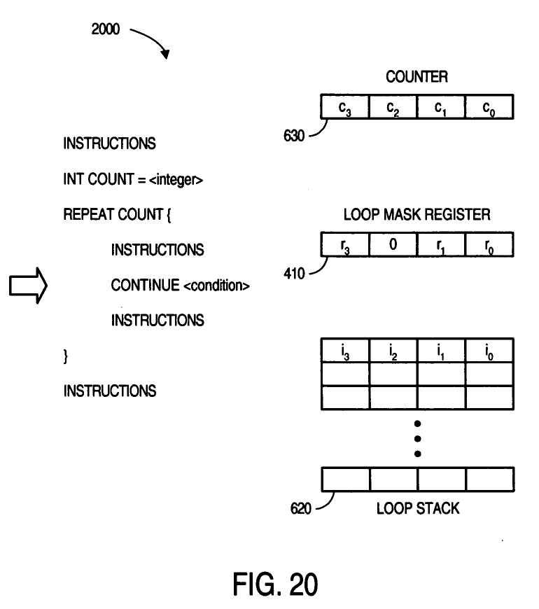

In addition, although particular instructions have been described herein as examples, embodiments may be implemented using other types of instructions. For example, FIG. 20 illustrates a SIMD execution engine 2000 executing a CONTINUE instruction according to some embodiments. In particular, the CONTINUE instruction is within a REPEAT loop that will be executed <integer> times. If, however, the <condition> is true during a particular pass through the loop, that pass will halt and the next pass will begin. For example, if the REPEAT loop was to be executed ten times, and the <condition> was true when the loop was executed for the fifth time, the instructions after the CONTINUE would not be executed and the loop would be begin execution of the sixth pass through the loop. Note that a BREAK<condition> instruction, on the other hand, would end the execution of the loop completely.

Consider, for example, the following instructions:

```
DO {
        Instructions
        CONTINUE <condition 1>
        Instructions
        CONTINUE <condition 2>
        Instructions
} While <condition 3>
```

In this case, two unique masks might be maintained: (i) a “loop mask” as described herein and (ii) a “continue mask.” The continue mask might, for example, be similar to the loop mask but instead records which execution channels have failed the condition associated with the CONTINUE instruction within a loop. If a channel is “0” (that is, has failed a CONTINUE condition), the execution on that channel may be prevented for the remainder of the that pass through the loop.

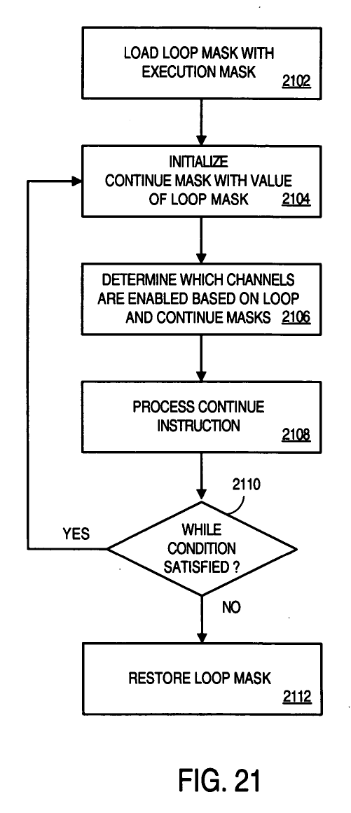

One method of executing such a CONTINUE instruction is illustrated in FIG. 21. According to this embodiment, just prior to loop entry at 2102 the execution mask is loaded into the loop mask (e.g., indicating which channels are enabled).

At 2104, the continue mask is initialized with the value of the loop mask prior to execution of the first instruction of the loop. At 2106, a determination is made as to which channels are enabled when loop instructions are executed. For example, execution might only be enabled only when the associated bit in both the loop mask and the continue mask equal one.

At 2108, a CONTINUE instruction is encountered. At this point, a condition associated with the CONTINUE instruction might be evaluated and the continue mask updated as appropriate. Thus, further instructions will not be executed during this pass through the loop for channels that encountered a CONTINUE instruction.

When the loop's WHILE instruction is encountered at 2110, the associated condition is evaluated. If the WHILE instruction's condition is satisfied for any channel (regardless of the channel's bit in the continue mask), the continue mask is again initialized with the loop mask and the process continues at 2104. If the WHILE instruction's condition is not satisfied for every channel, the loop is complete at 2112 and the loop mask is restored from the stack. If a loop is nested, the continue mask may be saved to a continue stack. When the interior loop completes execution, both the loop and continue masks may be restored. According to some embodiments, separate stacks are maintained for the loop mask and the continue mask. According to other embodiments, the loop mask and the continue mask may be are stored in a single stack.

The several embodiments described herein are solely for the purpose of illustration. Persons skilled in the art will recognize from this description other embodiments may be practiced with modifications and alterations limited only by the claims.

What is claimed is:

1. A method, comprising:
receiving a first loop instruction at an n-channel single instruction, multiple-data execution engine; and
copying information from an n-bit loop mask register to an n-bit wide, m-entry deep loop stack, where n and m are integers.

2. The method of claim 1, further comprising:
storing first loop information in the loop mask register.

3. The method of claim 2, wherein the first loop instruction is a DO instruction associated with a WHILE condition, and the first loop information stored in the mask register is to be based at least in part on an evaluation of the WHILE condition for at least one operand associated with a channel.

4. The method of claim 3, further comprising:
executing a set of instructions associated with the WHILE condition for at least one channel in accordance with the loop mask register; and
updating the loop mask register in accordance with an evaluation of the WHILE condition.

5. The method of claim 4, further comprising:
determining that the WHILE condition is still satisfied for at least one channel enabled by the loop mask register; and
jumping to the beginning of the set of instructions associated with the WHILE instruction.

6. The method of claim 4, further comprising:
determining that the WHILE condition is no longer satisfied for any channel enabled by the loop mask register; and
moving the information from the loop stack to the loop mask register.

7. The method of claim 2, wherein the second loop instruction is a REPEAT instruction.

8. The method of claim 7, wherein a REPEAT counter is maintained for at least one channel and further comprising:
executing a set of instructions associated with the REPEAT instruction for at least one channel in accordance with the loop mask register;
decrementing at least one REPEAT counter; and
determining if the loop mask register should be updated based on at least one REPEAT counter.

9. The method claim 8, further comprising:
determining that the REPEAT counter is not zero for at least one channel enabled by the loop mask register; and
jumping to the beginning of the set of instructions associated with the REPEAT instruction.

10. The method of claim 8, further comprising:
determining that the REPEAT counter is zero for all channels enabled by the loop mask register; and
moving information from the loop stack to the loop mask register.

11. The method of claim 2, further comprising:
receiving a second loop instruction at the execution engine;
moving the first loop information from the loop mask register to the loop stack; and
storing second loop information in the loop mask register.

12. The method of claim 1, further comprising:
receiving a BREAK instruction associated with the first loop instruction and a channel; and
updating the loop mask register bit associated with the channel.

13. The method of claim 12, further comprising prior to receiving the BREAK instruction:
receiving a first conditional instruction at the execution engine;
evaluating the first conditional instruction based on multiple operands of associated data;
storing the result of the evaluation in an n-bit conditional mask register;
receiving a second conditional instruction at the execution engine; and
copying the result from the conditional mask register to an n-bit wide, m-entry deep conditional stack.

14. The method of claim 13, further comprising after receiving the BREAK instruction:
moving at least one entry in the conditional stack to the conditional mask register.

15. The method of claim 2, further comprising:
receiving a CONTINUE instruction associated with the first loop instruction and a channel; and
updating the loop mask register bit associated with the channel.

16. The method of claim 1, wherein instructions are executed in accordance with information in the loop mask register and further in accordance with information in a conditional mask register.

17. The method of claim 1, further comprising prior to receiving the first loop instruction:
initializing the loop mask register based on channels to be enabled for execution.

18. The method of claim 1, wherein the loop stack is one entry deep.

19. An apparatus, comprising:
an n-bit loop mask vector, wherein the loop mask vector is to store first loop information, associated with a first loop instruction, for multiple channels; and
an n-bit wide, m-entry deep loop stack to store information that existed in the loop mask vector prior to the first loop instruction.

20. The apparatus of claim 19, further comprising:
an n-bit conditional mask vector, wherein the conditional mask vector is to store results of evaluations of: (i) an IF instruction condition and (ii) data associated with multiple channels; and
an n-bit wide, m-entry deep conditional stack to store information that existed in the conditional mask vector prior to the results.

21. The apparatus of claim 19, wherein the first loop information is to be transferred from the loop stack to the loop mask vector when all appropriate instructions associated with a second loop instruction have been executed.

22. The apparatus of claim 19, wherein the first loop instruction is a DO instruction or a REPEAT instruction.

23. An article, comprising:
a storage medium having stored thereon instructions that when executed by a machine result in the following:
receiving a first DO instruction at an n-channel single instruction, multiple-data execution engine;
storing first loop information in an n-bit loop mask register;
receiving a second DO instruction at the execution engine;
moving the first loop information to an n-bit wide, m-entry deep loop stack; and
storing second loop information in the loop mask register.

24. The article of claim 23, wherein execution of the instructions further results in:
moving the first loop information from the loop stack into the loop mask register when all appropriate instructions associated with the second DO instruction have been executed.

25. The method of claim 24, wherein execution of the instructions further results in:
receiving a BREAK instruction associated with the second DO instruction and a channel; and
updating the loop mask register bit associated with the channel.

26. A system, comprising:
a processor, including:
a bit loop mask vector, wherein the loop mask vector is to store first loop information, associated with a first loop instruction, for multiple channels, and
an m-entry deep loop stack to store the first loop information when a second loop instruction is executed by the processor, wherein m is an integer greater than one; and
a graphics memory unit.

27. The system of claim 26, wherein the first loop information is to be transferred from the loop stack to the conditional mask vector when all appropriate instructions associated with the second loop instruction have been executed.

28. The system of claim 26, further comprising:
an instruction memory unit.
